(19) United States
(12) Patent Application Publication
(10) Pub. No.: US 2001/0050325 A1
(43) Pub. Date: Dec. 13, 2001

(54) Flexible, adjustable support apparatus

(76) Inventors: David Dunay, Laurel Springs, NJ (US); James G. Furniss, Magnolia, NJ (US); Michael J. Prokapus, Magnolia, NJ (US); John T. Williams, Sicklerville, NJ (US)

Correspondence Address: Nancy A. Smith, Esq., 8 Glen Burnie Dr., Sicklerville, NJ, 08081, US

(21) Appl. No.: 09/875,207

(22) Filed: Jun. 6, 2001

Related U.S. Application Data
(60) Provisional application No. 60/210,506, filed on Jun. 9, 2000.

(51) Int. Cl. F16L 3/08

(52) U.S. Cl. 248/74.3

(57) ABSTRACT

An adjustable flexible strap for supporting and securing ducts, or like device, and the like formed of a strap member that has a fastener strap and a pair of integral support members integrally formed in the strap. When the fastener strap is separated from the integral support members a channel formed between the support members. One end of the strap can have an aperture formed therein to allow said strap to be attached to an existing structure such as a joist, beam or other support member. The other end of the strap has flap through which the fastener strap is inserted. When the fastener strap is inserted into the flap, the serrated edges of the fastener strap engage the sides of the flap opening, and the fastener strap and the support members form a loop. This loop encircles the duct, or like device, and cradles the duct in the support members, thereby securely suspending the duct from the joist, beam or other support member.

### CROSS-REFERENCE TO RELATED APPLICATIONS

The present application claims the benefit of U.S. Provisional Application No. 60/210,506 filed Jun. 9, 2000, the disclosure of which is hereby incorporated herein.

### BACKGROUND OF THE INVENTION

1. Field of the Invention

This invention relates generally to support mechanisms for conduit, pipes wires, or ductwork for air conditioning and heating systems for homes and buildings. More particularly, this invention relates to support mechanisms for conduit, pipes, wires or duct work which are both flexible and adjustable.

2. Description of the Prior Art

In air conditioning and heating systems for homes and other buildings, contractors typically employ ductwork for purposes of air and heat exchange between the air conditioning/heating unit and the areas to heated or cooled. Oftentimes, the ductwork used for heating and air conditioning systems is flexible. This flexible ductwork is commonly in the form of an expandable tube of reflective foil material over a framework of coiled ribs. The coiled ribs provide the only structure for the flexible duct work and thus it is susceptible to crimping, sagging, kinking, twisting and bending, all of which prevent the proper air flow through the duct work and could potentially cause damage to the ductwork.

Therefore it is important to support the flexible duct work in order to prevent the common problems of crimping, bending, kinking, twisting and sagging. In order to prevent such problems, people have used a variety of mechanisms to support the ductwork from an overhead position by attachment to a ceiling beam, joist or other support.

In the past, devices such as wires or thin straps, have been employed that wrap around the external walls of the ductwork and attach directly to the ceiling beam, joist or other support. Unfortunately, such wires or thin straps often rest between the ribs or steel spiral helix of the flexible duct work which causes crimping of the foil material and may even cause tears in the foil requiring replacement of the entire section of duct work. Additionally, such devices also cause sagging of the ductwork between such support devices.

Other support devices have included plastic mesh strips which are attached to the ceiling beam or joist and form a cradle for supporting the steel spiral helix of the flexible ductwork. Unfortunately, the weave of such plastic mesh strips is very thin and fragile and therefore difficult to install and easily torn. Additionally, once installed the mesh strips are not adjustable. If after installation, it is apparent that the ductwork is not properly supported, the mesh must be removed, scrapped and new piece reinstalled. This inability to adjust the strips on installed ductwork or other apparatus and the tendency of failure of the mesh strips makes it an unlikely choice for the support material.

Additionally, support mechanisms are often employed to support other systems such as wiring for electric, phone and cable; conduit for many purposes; pipes for many systems, and other non-flexible types of ductwork. In each of these cases, proper support of the wires, pipes, conduit, ductwork, or the like, is critical to proper operation of the system over long periods of time. Improper support can put stress on the system at connection points, as well as other points along the system's length, potentially leading to failure of the system and large repair costs for the home or business owner. In the past, several systems have been developed to attempt to solve these problems.

One such device is the simple strip mechanism shown in U.S. Design Pat. No. 293,203, issued to Hertensteiner, for a pipe support mechanism. However, this device does not appear to be adjustable, or reusable.

More stable and permanent support devices have also been developed in the past. Such prior art devices include the hanger shown in U.S. Pat. No. 3,892,378 issued to Lane. This patent discloses a metal hanger to be installed between the joists of a building structure composed of a pair of pivotally connected members that are adjustable to different spacing. The pipe or ductwork to be supported fits over top of the hanger. However, as several hangers would necessary to support a length of ductwork, the use of such metal hangers can be cost prohibitive. Additionally, the metal edges could rust and eventually damage the ductwork causing a need for repair.

Another duct support system of the prior art is shown in U.S. Pat. No. 5,230,190, issued to Schuette. The joist bridge and duct support shown in the '190 patent is formed of molded resin and is attached between two parallel spaced support beams or joists. The support is formed in an open rectangular shape having a center opening for receiving a piece of ductwork there through. This device functions in a dual manner to provide support between joists as a bridge and to support ductwork. However, the opening for receiving the duct is not adjustable. Moreover, hangers such as the devices shown in the '190 and '378 patents, require installation between two adjacent joists, which may be inconvenient or impractical.

Therefore, there is a need in the art of support mechanisms for a simple system to elevate and support flexible duct work, pipes, wiring, conduit, other types of ductwork and the like while preventing the crimping, kinking, bending, drooping and damage caused by the prior art systems. There is also a need to produce a support system that is easy and inexpensive to manufacture, is flexible yet durable, is easy to install and remove, allows for adjustment before, during and after installation, and is reusable.

### OBJECTS OF THE INVENTION

It is an object of the present invention to provide for a support system for ductwork, pipes, conduit, wires, or like which is flexible.

It is a further object to provide for a support system which is also adjustable.

It is still a further object of the present invention to provide for a support system which prevents crimping, sagging, kinking, bending, drooping and damage to the ductwork or other device being supported.

It is yet another object of the present invention to provide for a support system which is easy to install and remove.

It is still yet another object of the present invention to provide for a support system which can be attached to a support member such as a joist or beam in a plurality of ways.

It is still another object of the present invention to provide for a support system which employs an adjustable yet locking mechanism for changing and fixing the length of the system.

It is still a separate object of the present invention to provide for a support system which is easily manufacturable and can be made from a single piece of material.

It is still another object of the present invention to provide for a support system which can be used to support a variety items in a hanging fashion.

### SUMMARY OF THE INVENTION

The present invention provides for an adjustable flexible strap for supporting and securing ducts, or like devices, formed of a single strap member. The strap is formed having a fastener strap and a pair of integral support members integrally formed from a single piece of flexible material. When the fastener strap is separated from the integral support members a channel formed between the support members. This channel acts a cradle to support a section of duct work, pipe, conduit or wires. One end of the strap can have an aperture formed therein to allow the strap to be attached to an existing structure such as a joist, beam or other support member. The other end of the strap has flap through which the fastener strap is inserted. When the fastener strap is inserted into the flap, the serrated edges of the fastener strap engage the sides of the flap opening, and the fastener strap and the support members form a loop. This loop encircles the duct, or like device, and cradles the duct in the support members, thereby securely suspending the duct from the joist, beam or other support member.

The strap is preferably formed from a single piece of flexible material such as plastic, PVC or high density polyethylene. Once the single piece is formed in the desired shape, such as an elongated rectangle, the fastener strap, support members and channel can be formed by die cutting or laser cutting the flexible material. This single-piece construction makes the device both easy to manufacture and easy to use. Single-piece construction additionally makes mass manufacture of the device straightforward and inexpensive.

### BRIEF DESCRIPTION OF THE DRAWINGS

FIG. 1 is top plan view of the strap of the present invention;

FIG. 2 is a perspective view of the strap of the present invention shown supporting a section of ductwork from a joist;

FIG. 3 is a side view of the strap of the present invention; and

FIG. 4 is perspective view of one method of installing the present invention;

FIG. 5 is a perspective view of the fastener strip 12 being inserted through the locking receiver loop 14.

FIG. 6 is a perspective view of second method of installation of the strap of the present invention.

### DETAILED DESCRIPTION OF THE PREFERRED EMBODIMENT

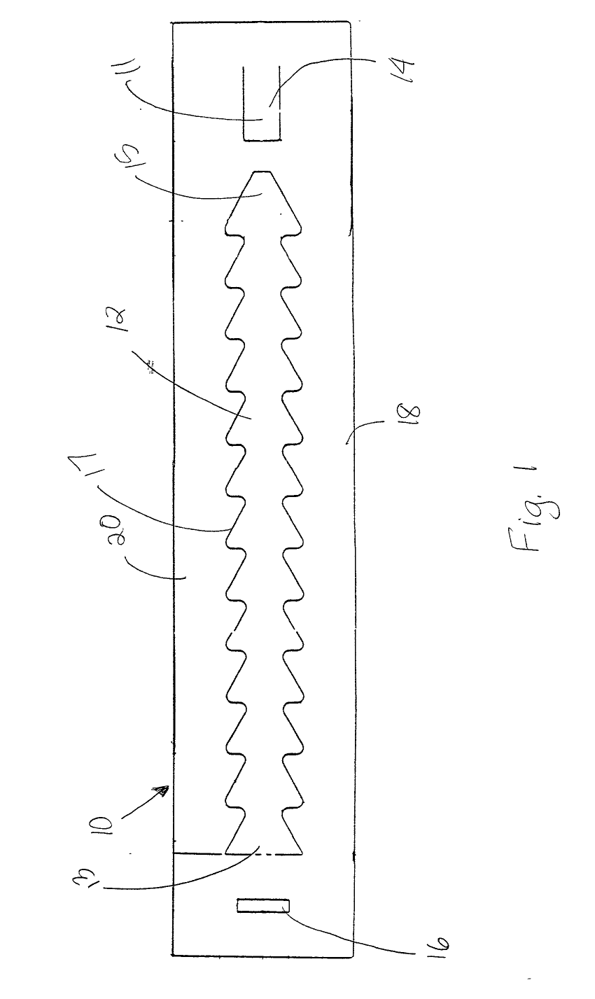

The present invention is a strap 10 for both hanging and supporting insulated, non-insulated, flexible and rigid ductwork, as shown in FIG. 1, as well as steel and plastic conduit, wiring, tubing, cabling, and pipes. While it is understood, that the strap of the present invention can be used to support each of the devices listed above, as well as other like devices, the invention will be described in greater detail with respect to the support of ductwork in general. This is not intended to limit the scope of the invention, but merely to provide an illustrative embodiment of the present invention. The device can be used in a manner similar to the manner described below for supporting other devices, such pipes, conduit, wiring, cabling and other systems.

The strap 10 is designed both (a) to support ductwork, or other apparatus, and (b) to provide a means for securing the ductwork in place. The strap 10 is a strip which can be made from a flexible, lightweight yet durable material such as plastic, vinyl, rubber, PVC, high density polyethylene, aluminum, fiberglass or any other suitable flexible material. The strap 10 can be made by forming strips of the plastic or other material and then die cutting, laser etching or stamping the cuts to make the adjustable locking fastener strip 12, the locking receiver loop 14 and the suspension loop 16. The support loops 18 and 20 are formed along the sides of the locking fastener strip 12. Alternatively, the strap could be manufactured through other means such as injection molding, extrusion, or any other suitable method depending on the material used.

The locking fastener strip 12 is attached to the strap 10 at one end 13 and detached at the other locking end 15. In use the locking fastener strip 12 is pulled away from the support loops 18 and 20 such that a recess or channel 19 is formed therebetween. When the locking fastener strip 12 is pulled away from the support loops 18 and 20, the length of the strap 10 is nearly doubled.

The edges of the locking fastener strip 12 as shown in FIGS. 1 an 2 are serrated 17 to allow for the strip 12 to securely engage the locking receiver loop 14 when the fastener strip 12 is inserted therethrough. The plurality of serrated edges 17 along the length of the fastener strip 12 allows for adjustment of the length of the strap 10 in use. The serrations could be replaced with ridges, bumps, dimples, pleats or other means to lockingly engage the fastener strip 12 in the receiver loop 14 that also allow for adjustment of the length of the strap, and removal of the strap altogether.

Locking receiver loop 14 is formed having a flap 11, which provides an additional means for securing the fastener strip 12 in loop 14. Locking receiver loop 14 is formed such that the width of the opening in the loop 14 is substantially smaller than its length. This provides for easy insertion of the fastener strip 12 while also providing for a secure engagement of the serrated edges 17 of the fastener strip 12.

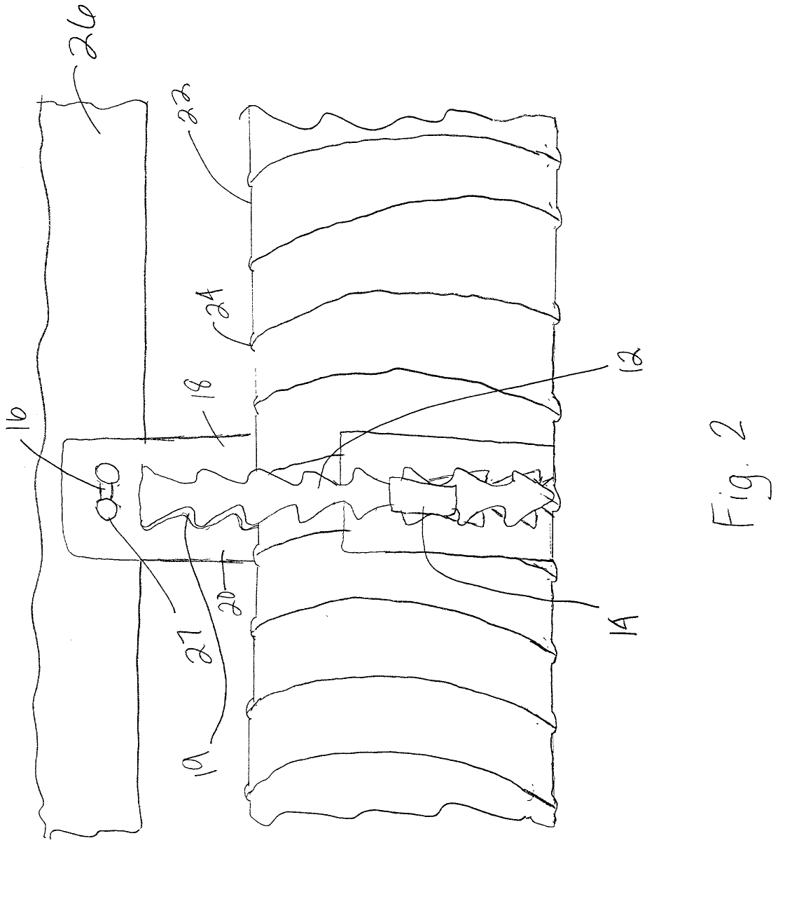

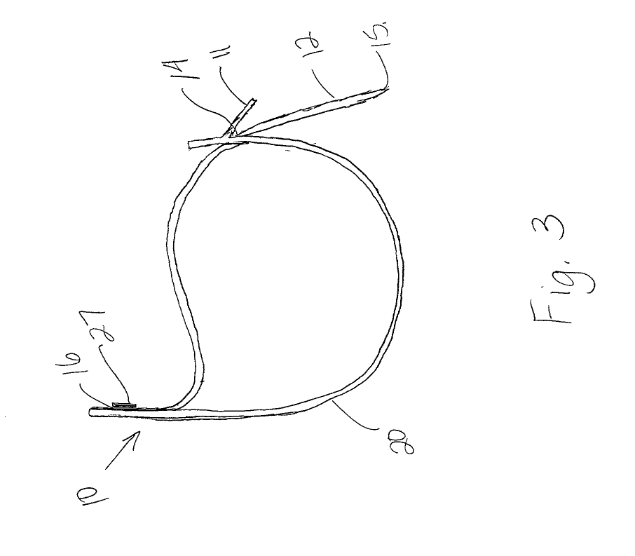

The strap is lightweight, flexible and strong to allow easy manipulation of the strap during installation. FIGS. 2 and 3 illustrate one method for installing the strap 10 to support a length of flexible ductwork 22 in an HVAC system.

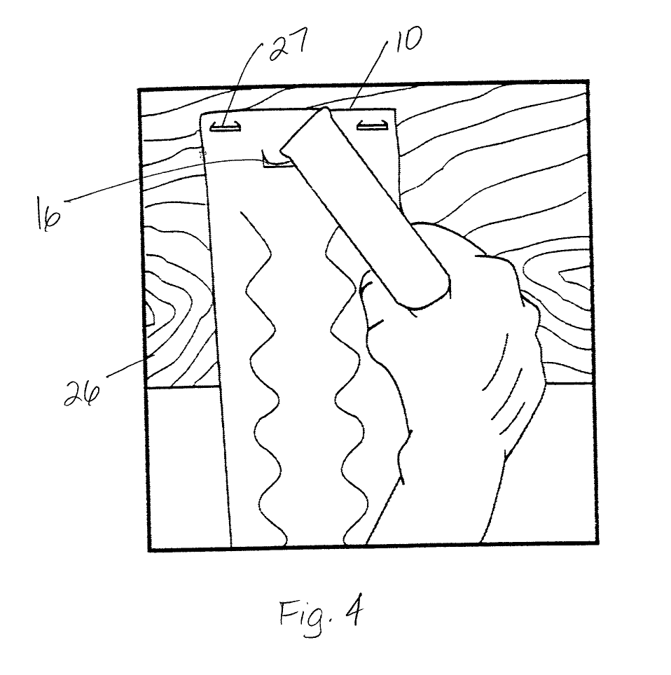

In FIG. 2, the strap 10 is installed by attaching the suspension loop 16 to the joist or other support member 26 by means of one or more fasteners 27 such as nails, screws, tacks or staples. The system is designed to allow the use of one or more fasteners depending on the application, the length and the weight of the ductwork to be supported. In an alternate method of attaching the strap 10 to the support member 26 shown in FIG. 4, fasteners are inserted through the top portion of the strap 10 above suspension loop 16. In this method two or more fasteners 27 can be used on either edge of the strap 10 to provide additional strength if needed.

Next, support loops 20 and 18 are wrapped around the outer surface of a section of flexible duct work 22 such that the support loops 18 and 20 pass along the bottom portion of the duct work 22. The support loops 18 and 20 are then pulled up the other side of the section of duct work 22 such that the duct work is now cradled by the support loops 18 and 20.

The support loops 18 and 20 are positioned along the flexible duct work 22 such that one or more of ribs 24 of the steel spiral helix of the flexible duct fit into support recess 19 formed in between the support loops 18 and 20. This positioning of the strap 10 and the support recess 19 formed between support loops 18 and 20 prevents any crimping, kinking, sagging or choking of the duct work 22 allowing for the proper flow of air through the flexible duct for efficient functioning of the HVAC system. Additionally, the support recess 19 should be made large enough to prevent any sagging or drooping of the duct work, which can also reduce the efficiency of the HVAC system.

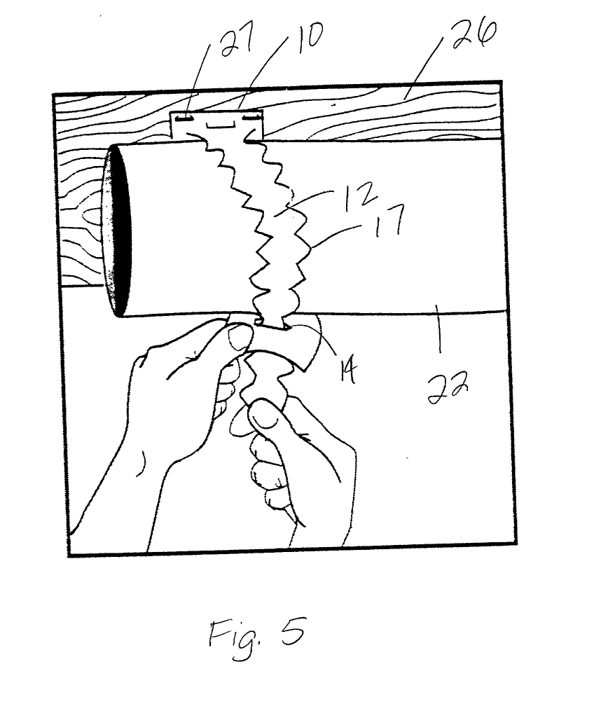

The adjustable locking fastener strip 12 is looped over the top portion of the flexible duct work 22 such that it meets the end of the strap 10 which terminates in the locking receiver loop 14. The fastener strip 12 is then inserted into the locking receiver loop 14, as shown in FIG. 5 and the serrated edges 17 are engaged for secure attachment. The length of the strap 10 can then be adjusted by pulling the locking end 15 of the fastener strip 12 further through the locking receiver loop 14 until the desired length is reached. Each serrated edge 17 of the locking fastener strip 12 provides an additional adjustment position for determining the overall length of the strap 10. Each serrated edge acts a notch in the strap for shortening, or lengthening, the strap. As the locking end 15 of the fastener strip 12 is pulled further and further through the locking receiver loop 14 the length of the strap 10 is shortened.

FIG. 3 shows a side view of the system illustrating clearly how the support loops encircle the bottom of the duct work for support and the fastener strip 12 engages locking receiver loop 14 to secure the section of flexible duct with in the strap.

The strap is also easily removable. In order to disengage the serrated edges 17 from the locking receiver loop 14, the fastener strip 12 is twisted to one side such that the width of the strip 12 is now positioned in the locking receiver loop 14 lengthwise. The strip 12 is then easily removable from the loop 14. This ability to disengage the serrated edges 17 from the locking receiver loop 14 allows the strap 10 to be reused. For example, if the ductwork, pipe, conduit or wiring, should become damaged for any reason, the straps can be disengaged to remove the damaged section or sections, and re-engaged when the new ductwork is in place. This feature makes the straps reusable as well. Additionally, the fasteners 27, can be removed as well to allow for adjustment of the placement straps along the length of the ductwork.

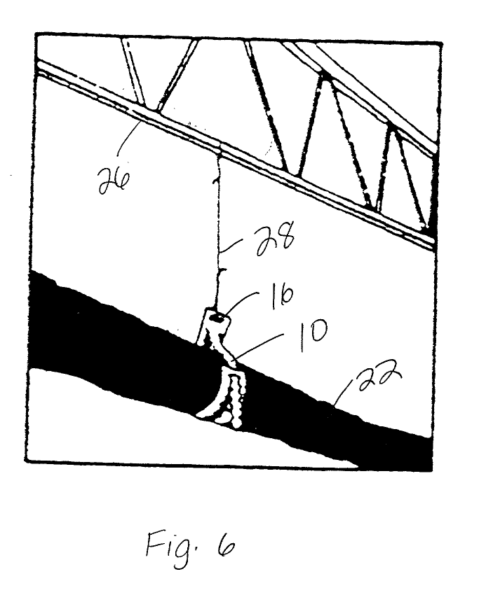

FIG. 6 is a perspective view illustrating an alternative method of attaching or hanging the strap 10 from a support member. Suspension devices 28 such as ceiling grid wire, plastic perforated straps, wire, string, or the like can be fastened through suspension loop 16 and attached to a joist or other support. This allows for the ductwork or other device to be supported from a joist or other support member that is positioned some distance from the ductwork. The support loop 16 provides the system with this additional flexibility in mounting methods. Additionally, the strap can be used with out the support loop 16, by encircling the support member, such as a pipe, or other framework, with the strap 10, such that the duct work and the support member are both encircled by the strap 10.

Moreover the present invention can be used to support or hang more than just ductwork, pipes, conduit, wires or the like. Its flexible nature, combined with the ease of adjustment and reuse, allow this device to be used to secure and support a variety of devices for a variety of uses. For example, the strap could be used to secure a coiled length of hose, cable, or cord and hang it from a hook in a garage, shed or basement. A pair of straps could secure a bicycle, or other device from a wall or ceiling. These examples are merely illustrative, and therefore any variety of uses for such adjustable, flexible straps could be envisioned which would be within the scope of this invention.

While the particular illustrative embodiments shown and described above will be useful in many applications for producing a flexible support strap, further modification to the present invention herein disclosed will occur to persons skilled in the art. All such modifications are deemed to be within the scope and spirit of the present invention defined by the appended claims.

What is claimed is:

1. A duct support device comprising:
a strap having:
(i) a fastener portion formed in said strap with a plurality of serrations formed along the length of said fastener portion;
(ii) a pair of support members having a channel formed there between;
(iii) a first end having means for attaching said strap to an existing structure; and
(iv) a second end having means for receiving and lockingly engaging said serrations of said fastener portion;
whereby when said fastener portion is inserted through said receiving means of said second end of said strap one of said plurality of serrations lockingly engages said second end of said strap, and a support loop is formed.

2. The device of claim 1, wherein said attaching means is an aperture for receiving a fastener therethrough.

3. The device of claim 2, wherein said means for receiving and engaging said serrations is a flap member.

4. The device of claim 3, wherein said fastener portion, said plurality of serrations, said pair of support members, said aperture and said flap are formed in said strap by die cutting.

5. The device of claim 1, wherein said strap is made from a flexible material.

6. The device of claim 5 wherein said flexible material is one from a group consisting of plastic, high density polyethylene, rubber, fiberglass, vinyl, PVC or aluminum.

7. An adjustable flexible strap for supporting and securing ducts, comprising:
a strap member having:
(i) a fastener portion formed in said strap member;
(ii) a support portion;
(iii) a first end for attaching said strap member to an existing structure; and
(iv) a second end having an aperture for receiving and engaging said fastener portion;
whereby when said fastener strap is inserted through said aperture a support loop is formed by said fastener portion and said support member for receiving said duct therein.

8. An adjustable flexible strap as recited in claim 7, wherein said fastener portion has a plurality of serrations formed along its length.

9. An adjustable flexible strap as recited in claim 8 wherein said plurality of serrations provides for adjustment of the length of said strap member.

10. An adjustable flexible strap as recited in claim 8 wherein said second end of said strap member further has a flap portion which lockingly engages one set of said plurality of serrations.

11. An adjustable flexible strap as recited in claim 10, wherein said fastener strap, said plurality of serrations, said support strap member, said aperture and said flap means are formed in said strap member by means of die cutting.

12. An adjustable flexible strap as recited in claim 7, wherein said strap is formed of a flexible material which is one of a group consisting of plastic, high density polyethylene, rubber, fiberglass, vinyl, PVC or aluminum.

13. An adjustable flexible strap as recited in claim 7, wherein said support member has channel formed along the central longitudinal axis thereof.

14. An adjustable flexible strap as recited in claim 10, wherein said strap is in the shape of an elongated rectangle.

15. A method for hanging and supporting ducts or other devices from an existing structure comprising the steps of:
attaching a strap to an existing support structure with a fastener;
separating said strap into a pair of support members and a fastening portion characterized by a plurality of serrations;
wrapping said pair of support straps around a bottom side of a section of duct;
inserting one end of said fastening portion through a receiving means formed in an end of said strap member to form a support loop;
adjusting the length of said strap by pulling said fastening portion through said receiving means until the desired length is reached and such that said duct is secured within said support loop; and
engaging one of said plurality of serrations with said receiving means such that said desired length is fixed.
